(19) United States
(12) Patent Application Publication
(10) Pub. No.: US 2007/0243002 A1
(43) Pub. Date: Oct. 18, 2007

(54) Interconvertible structure of alphabetic-numeric keyboard

(76) Inventor: Elton Yu Man Leung, Hong Kong (HK)

Correspondence Address: HAMRE, SCHUMANN, MUELLER & LARSON, P.C., P.O. BOX 2902, MINNEAPOLIS, MN, 55402-0902, US

(21) Appl. No.: 11/403,454

(22) Filed: Apr. 13, 2006

(51) Int. Cl. B41J 5/00

(52) U.S. Cl. 400/485

(57) ABSTRACT

An interconvertible structure of alphabetic-numeric keyboard provided comprises of four lines of keys, wherein keys of the second, third and fourth are movable horizontally; a movable sheet is arranged on the on the lower edge of each key of each line; a converting mechanism connected with said movable sheet by a pivot; and a drafting mechanism connected with said converting mechanism. In accordance with the present invention, the interconvertible structure of alphabetic-numeric keypad utilizes this re-alignment technology so that the user is only required to push the drafting mechanism 4, for the alphabetic keys, obliquely arrayed, to be aligned into a conventional numeric keypad. This decreases the probability of typographical errors and makes the input of numbers more convenient on the portable computer.

### BACKGROUND OF THE INVENTION

1. Field of the Invention

The present invention relates to a keyboard, and more especially to an interconvertible structure of alphabetic-numeric keyboard.

2. Description of the Prior Art

Portable computers are becoming increasing popular, so popular that a good percentage of consumers are buying portable computers as a desktop computer replacement. Although the compact size is a main buying reason for many consumers, this advantage comes with one caveat. The limitation of size of these portable computers reduces the size of the usable keyboard and for many of these smaller keyboards, the numeric keypad is almost always assimilated from the keyboard.

This method of inputting numbers is difficult and can be quite inconvenient to those who are used to using the normal numeric keypad. It also becomes difficult for those input methods utilizing the numeric keypad as the input keys.

To solve this problem, many manufacturers functionally convert the alphabetic keys of U, I, O, J, K, L, M into the numeric keys of 4, 5, 6, 1, 2, 3, 0 respectively with an engagement of the Num Lock key. Despite this effort to include a numeric keypad into the alphabetic keyboard, it is not very user-friendly as the user would have to learn from scratch on how to use the keypad.

Almost all popular alphabetic keyboard use an oblique orientation for the alphabet keys. It is because the modern alphabetic keyboards are developed from western typewriters. This is to facilitate typing with ten fingers and to increase the typing speed, keys of each line are not align with those of next line (see FIG. 1), but have a deviation of from one-third to a half key pitch.

However, the keys of conventional numeric keypads are lined up in a straight way, which, when used, impose a big difference to the alphabetic keyboard. Because most users are accustomed to the alignment of the conventional numeric keypad, this oblique keypad assimilated into the alphabetic keyboard leads to higher probability of typographical errors.

### BRIEF SUMMARY OF THE INVENTION

A primary object of the present invention is to provide an interconvertible structure of alphabetic-numeric keyboard which can serve as a numeric keypad on a keyboard of a portable computer so as to make the number input very easy without any element additionally carried.

To achieve the above-mentioned object, an interconvertible structure of alphabetic-numeric keyboard provided comprises: four lines of keys, wherein keys of the second, third and fourth are movable horizontally; a movable sheet arranged below keys of each line; a converting mechanism connected with said movable sheet by a pivot; and a drafting mechanism connected with said converting mechanism.

In accordance with the present invention, the interconvertible structure of alphabetic-numeric keyboard utilizes the re-alignment technology so that the user only requires to push the drafting mechanism 4, and then the alphabetic keys obliquely arrayed are aligned as a normal numeric keypad. This method would reduce the typing error and the input of number becomes as easy as using a conventional keypad.

Other objects, advantages and novel features of the present invention will become more apparent from the following detailed description when taken in conjunction with the accompanying drawings, in which:

### BRIEF DESCRIPTION OF THE DRAWINGS

FIG. 1 is a plan view showing an alphabetic keypad mode in accordance with the present invention.

FIG. 2 is a plan view showing a numeric keypad mode in accordance with the present invention.

FIG. 3 is a plan view showing another embodiment in accordance with the present invention.

### DETAILED DESCRIPTION OF THE INVENTION

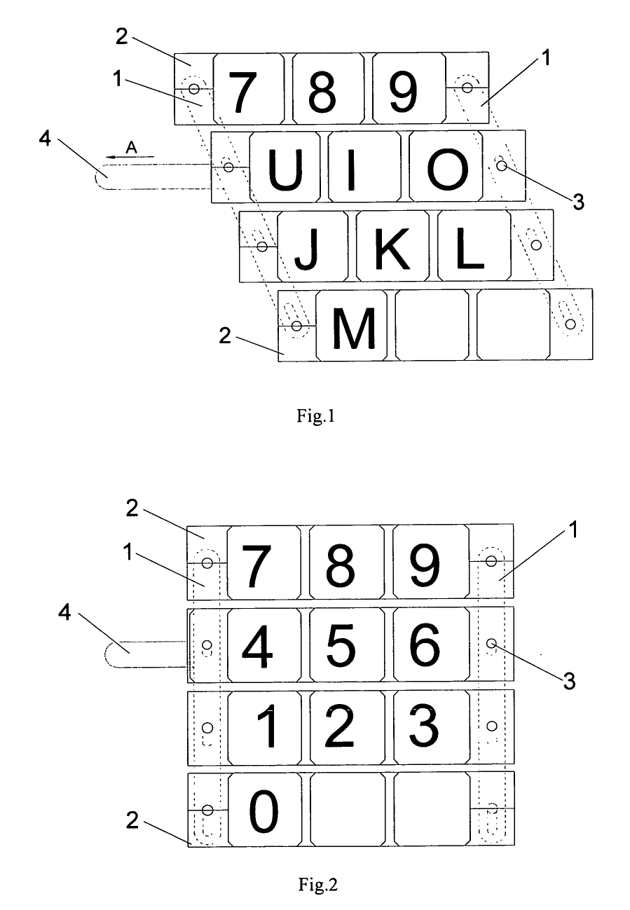

Referring to FIG. 1, an interconvertible structure of alphabetic-numeric keypad in accordance with the present invention is obliquely arrayed under an alphabetic keypad mode like a common keyboard of a portable computer. In this embodiment choose the alphabetic keys of U, I, O, J, K, L, M to be converted into the numeric keys of 4, 5, 6, 1, 2, 3, 0 and form a new numeric keypad together with the present numeric keys of 7, 8, 9.

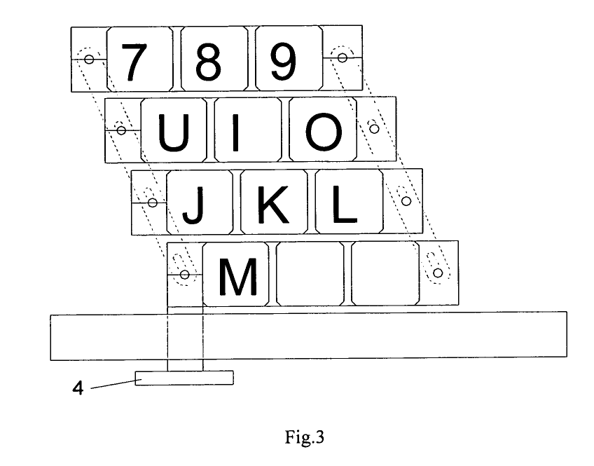

In the alphabetic keypad mode shown in FIG. 1, there are four lines keys: keys of the first line are 7, 8, 9; keys of the second line are U, I, O; keys of the third line are J, K, L; and keys of the fourth line are M, “,”, “.”, wherein keys of the first line are fixed but keys of the rest lines are movable. A movable sheet 2 is formed below each line. A converting mechanism 1 is arranged on both ends of the movable sheet 2. In this embodiment the converting mechanism 1 includes a pair of connecting rods. The connecting rods 1 are connected with each movable sheet respectively by a pivot 3. The connecting rods 1 also connect a drafting mechanism 4. The drafting mechanism 4 extends beyond the whole keyboard of the portable computer and it is located on the left or the right of the keyboard or below the Space Bar key (shown in FIG. 3). The drafting mechanism 4 can be a handle, a cable or other gearings. When a user operate the drafting mechanism 4 along a direction A shown in FIG. 1, the connecting rods 1 are then moved. With aid of the pivot 3, the keys of the second, third and fourth line are transversely shifted by a half key pitch, three-quarter key pitch, one and one-third key pitch respectively (see FIG. 2), to be aligned with the first line. Thus, a numeric keypad having four lines of functional numeric keys is formed. It should be note that the shifted key pitches of the second, third and fourth line are not limited to the disclosure in this embodiment. The actual numerical value depends on the design of the keyboard. The principle to be conformed is that all the lines should be aligned after shifted.

Actually, since transverse move is required, the whole area of alphabetic keys from the second line to the fourth line of the portable computer would be set as movable keys. For a brief illustration, in this embodiment it is only choose an area shown in FIGS. 1-3 as an example.

The Tab key, Caps Lock key and the Shift key are generally arranged on an edge area of the keyboard and all have a relatively large size. To ensure enough shift space for the second, third and fourth line, the size of those keys should be reduced or other alteration.

When the use as a numeric keypad is over, operate the drafting mechanism 4 again to make the keys of the second, third and fourth line to return their original position, that is, a mode of a common alphabetic keyboard is resumed.

The present invention is available in any device which has an alphabetic keyboard but no numeric keypad. Those devices include portable computers, PDAs, mobile phones, typewriters and word processors. All of the devices mentioned are essential to people's life, the present invention is commercially valuable accordingly.

The present invention utilizes the re-alignment technology so that the user only requires to push the drafting mechanism 4, and then the alphabetic keys obliquely arrayed are aligned as a normal numeric keyboard. It really reduce the opportunity of wrong typing and the number input becomes very easy.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An interconvertible structure of alphabetic-numeric keyboard comprising:
four lines of keys, wherein keys of the second, third and fourth are movable horizontally;
a movable sheet arranged below said keys of each line;
a converting mechanism connected with said movable sheet by a pivot; and
a drafting mechanism connected with said converting mechanism.

2. The structure as claimed in claim 1, wherein said the keys of the second, third and fourth line are transversely shifted by a certain distance respectively through said drafting mechanism to be aligned with the first line.

3. The structure as claimed in claim 2, wherein said the keys of the second, third and fourth line are transversely shifted by a half key pitch, three-quarter key pitch, one and one-third key pitch respectively.

4. The structure as claimed in claim 1, wherein said converting mechanism includes a pair of connecting rods which are connected on both ends of said movable sheet.

5. The structure as claimed in claim 1, wherein said drafting mechanism is a handle or a cable extending beyond the whole keyboard and located on the left or the right of the keyboard or below the Space Bar key.

6. The structure as claimed in claim 1, wherein said keys of the first line are 7, 8, 9; keys of the second line are U, I, O; keys of the third line are J, K, L; and keys of the fourth line are M, “,”, “.”.

7. An interconvertible structure of alphabetic-numeric keyboard comprising:
four lines of keys, wherein keys of the second, third and fourth are shiftable transversely;
a movable sheet arranged below said keys of each line;
a transforming mechanism connected with said movable sheet through a pivot; and
a drafting mechanism connected with said converting mechanism.

8. The structure as claimed in claim 7, wherein said the keys of the second, third and fourth line are transversely shifted by a certain distance respectively through said drafting mechanism to be aligned with the first line.

9. The structure as claimed in claim 8, wherein said the keys of the second, third and fourth line are transversely shifted by a half key pitch, three-quarter key pitch, one and one-third key pitch respectively.

10. The structure as claimed in claim 7, wherein said converting mechanism includes a pair of connecting rods which are connected on both ends of said movable sheet.

11. The structure as claimed in claim 7, wherein said drafting mechanism is a handle or a cable extending beyond the whole keyboard and located on the left or the right of the keyboard or below the Space Bar key.

12. The structure as claimed in claim 7, wherein said keys of the first line are 7, 8, 9; keys of the second line are U, I, O; keys of the third line are J, K, L; and keys of the fourth line are M, “,”, “.”.

13. An interconvertible structure of alphabetic-numeric keyboard comprising:
four lines of keys, wherein keys of the second, third and fourth are movable horizontally;
a movable sheet arranged below said keys of each line; and
means for converting said movable line of keys which are originally obliquely arrayed to align with said first line of keys.

14. The structure as claimed in claim 13, wherein said means includes a converting mechanism connected with said movable sheet through a pivot, and a drafting mechanism.

15. The structure as claimed in claim 13, wherein said converting mechanism includes a pair of connecting rods which are connected on both ends of said movable sheet.

16. The structure as claimed in claim 15, wherein said drafting mechanism is connected with said connecting rods.

17. The structure as claimed in claim 13, wherein said the keys of the second, third and fourth line are transversely shifted by a certain distance respectively through said drafting mechanism to be aligned with the first line.

18. The structure as claimed in claim 17, wherein said the keys of the second, third and fourth line are transversely shifted by a half key pitch, three-quarter key pitch, one and one-third key pitch respectively.
